(19) United States
(12) Patent Application Publication
(10) Pub. No.: US 2010/0285713 A1
(43) Pub. Date: Nov. 11, 2010

(54) METHOD FOR TREATING FABRICS

(76) Inventors: Nigel Patrick Somerville Roberts, Newcastle upon Tyne (GB); Alessandro Corona, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/772,359

(22) Filed: May 3, 2010

Related U.S. Application Data
(60) Provisional application No. 61/176,145, filed on May 7, 2009.

(51) Int. Cl. C11D 3/60

(52) U.S. Cl. 442/96; 510/527

(57) ABSTRACT

An emulsion for treating natural fabrics is provided wherein the emulsion comprises a natural conditioning agent, water, perfume and is essentially free of cationic surfactant. Also included is an article for treating natural fabrics, a kit for treating natural fabrics, and a method of treating natural fabrics in a dryer.

### CROSS REFERENCE TO RELATED APPLICATIONS

This application claims the benefit of U.S. Provisional Application Ser. No. 61/176,145, filed May 7, 2009.

### TECHNICAL FIELD

The present invention is in the field of fabric treatment. In particular, it relates to an emulsion comprising a natural-conditioning agent for conditioning of natural fabrics, a natural-fabric treating article comprising the emulsion and a method of treating natural fabrics with the treating article in a dryer. The method provides outstanding care and rejuvenation of natural fabrics.

### BACKGROUND OF THE INVENTION

Some fabrics are difficult to care for, in particular natural fabrics. They cannot be easily cleaned or de-wrinkled using traditional methods. Natural fabrics, such as woollens and silk-containing fabrics, can deform (shrink, stretch or simply alter their original shape) if subjected to a wet laundry process and/or ironing.

Sometimes fabrics are not soiled or stained but they have acquired unpleasant odours and/or they have lost their initial soft and fluffy feeling. In these cases, fabrics may not require to be cleaned but only refreshed or reconditioned to recover their initial properties. There is a need for articles and methods suitable for refreshing and conditioning delicate fabrics such as natural fabrics.

### SUMMARY OF THE INVENTION

According to a first aspect of the invention, there is provided an emulsion for treating natural fabrics. The emulsion comprises, by weight of the emulsion:
a) from about 1% to about 50%, preferably from about 5% to about 30% and more preferably from about 10% to about 25% of a natural-conditioning agent for natural fabrics;
b) from about 49% to about 98%, preferably from about 40% to about 80% and more preferably from about 50% to about 78% of water;
c) from about 0.01% to about 5%, preferably from about 0.05% to about 3% and more preferably from about 0.1% to about 1% of perfume; and
d) less than 5% of cationic surfactant.

The emulsion of the invention provides excellent care of natural fabrics, including refreshing and rejuvenation of the fabrics. By the term “natural fabrics” is meant herein any fabric made of a natural material, or containing a significant proportion of a natural material. By “significant proportion” is meant at least 5%, preferably at least 20%, more preferably at least 60% and especially at least 90% by weight of the fabric of a natural material. Natural material includes wool, silk, cotton, linen, etc. Preferred materials for use here in are wool and silk. The emulsion of the invention is preferably used for treating fabrics containing significant proportions of wool or silk. The term “woollens” as used herein refers to fabrics having a significant proportion of wool.

By “conditioning agent” is herein meant any agent capable of providing fabric conditioning, including softening, dewrinkling, malodour removal, shape recovery, perfuming, etc, preferably softening, dewrinkling and shape recovery. By “natural conditioning agent” is meant a conditioning agent obtained from a natural source.

Natural-conditioning agents include lipids. Preferred lipids for use as conditioning agents include fats, oils, waxes, monoglycerides, dyglycerides, etc. Conditioning agents of vegetal origin are preferred for use herein and in particular essential oils. Essentials oils not only provide fabric conditioning benefits but also could impart moisturizing and skin soothing properties when the treated fabric is in contact with human skin.

In preferred embodiments the emulsion comprises a surfactant, preferably in a level of from about 2% to about 20%, more preferably from about 4% to about 15% and especially from about 5% to about 10% by weight of the emulsion. Preferably the surfactant is derived from natural materials and is non-ionic and/or anionic. The surfactant can contribute to the emulsification of the natural-conditioning agent.

In preferred embodiments the emulsion comprises an organic solvent, preferably in a level of from about 2% to about 20%, more preferably from about 4% to about 15% and especially from about 5% to about 10% by weight of the emulsion. The organic solvent can further contribute to the emulsification of the natural-conditioning agent and can provide antibacterial benefits.

Preferably, the emulsion of the invention comprises less than 5%, more preferably less than 1% and especially less than 0.1% by weight of the emulsion of cationic surfactant. The intent of the composition of the present invention is to provide a high level of benefits to natural fabrics, therefore the present inventions aims to obviate the use of artificial actives such as cationic surfactants. Any cationic surfactants could also complex with any anionic surfactant present in the emulsion and degrade performance.

According to a second aspect of the invention, there is provided an article for treating natural fabrics, preferably for treating fabrics containing significant proportions of wool or silk, more preferably an article for treating woollens. The article comprises a substrate and the emulsion according to the first aspect of the invention. The substrate is preferably flexible and the emulsion is coated or absorbed onto it.

The absorbent capacity of the substrate is important. A substrate with low absorbency can release the composition too fast, contributing to staining of the treated fabrics. A substrate with high absorbency can be ineffective because it only releases a small amount of the material coated or absorbed into it.

Preferably the substrate is a non-woven cloth, more preferably in the form of a sheet.

According to a third aspect of the invention, there is provided a kit for treating natural fabrics, preferably a kit for treating fabrics containing significant proportions of wool or silk, more preferably for woollens. The kit comprises the fabric treating article of the invention and a non-collapsible bag. The kit is to be used in a dryer, preferably in a tumble dryer. The kit of the present invention preferably further comprises a stain removal applicator as described in U.S. Pat. No. 7,442,678, U.S. Pat. No. 6,838,423 and U.S. Pat. No. 6,644,879. This allows cleaning of stained fabrics that can be later conditioned using the method described herein below. This provides a complete treatment of natural fabrics including cleaning and conditioning, without using a traditional washing method. The cleaning action of the stain removal composition is further promoted by the hot and humid conditions found within a tumble dryer.

According to the last aspect of the invention, there is provided a method of treating natural fabrics in a dryer, preferably a tumble dryer, the method is preferred for treating fabrics containing significant proportions of wool or silk, more preferably woollens. The method uses the kit of the present invention. The fabrics to be treated are introduced, preferably dry, together with the article of the invention in a bag, the bag is sealed and subjected to tumbling and heat. The method is extremely convenient (avoid washing and still provides good cleaning) and easy to implement.

In preferred embodiments the tumble dryer is operated at temperature above 40° C., preferably between 80° C. and 45° C. this temperature range promotes the deposition of the natural-conditioning agent on the fabrics. The tumbling and optional (but preferred) heating is preferably carried out for a period of at least about 10 minutes, typically from about 20 minutes to about 30 minutes.

The bag is preferably non-collapsible. By “non-collapsible bag” herein is meant an air tight bag, i.e., a bag that can be inflated (i.e. filled with air) and sealed and the air will remain in it until the bag is open again. The volume of the bag is greater than the volume of the fabrics to be incorporated therein. The bag not only protects the fabrics from the friction with the drum of the tumble dryer but also limits the tumbling action of the fabrics to reduce fabric damage and provides a confined environment which helps to generate a high localised humidity and which assists the deposition of the natural-conditioning agent and perfumes on the fabrics. The bag also allows the use of perfume components more volatiles than if the fabrics were directly placed into the drum of the dryer. Preferably the bag has non-abrasive closure means, more preferably the non-abrasive closure means is a zip.

The method provides excellent care, refreshing and rejuvenating benefits to the treated natural fabrics. This method is more efficient, in terms of amount of active needed, than if the same benefits were to be delivered through the wash (i.e., traditional washing machine). Conventional softening actives are usually cationic materials which help deposition onto fabrics in the wash. The naturally-based materials used in the present invention are not cationic and hence would not be efficiently deposited in a wash. Through the wash the actives get diluted with the wash water and then washed away in the rinse, thereby making more difficult the deposition of actives on fabrics.

### DETAILED DESCRIPTION OF THE INVENTION

The present invention envisages: i) an emulsion comprising a natural-conditioning agent for treating natural fabrics, preferably for treating fabrics containing significant proportions of wool or silk; ii) an article for treating natural fabrics comprising a substrate coated or impregnated with a natural-conditioning agent; iii) a kit for treating natural fabrics, preferably for treating fabrics containing significant proportions of wool or silk, the kit comprising the treating article and a non-collapsible bag; and iv) a method for treating natural fabrics, preferably for treating fabrics containing significant proportions of wool or silk, in a tumble dryer using the kit. The method provides outstanding care for natural fabrics, in particular fabrics containing significant proportions of wool or silk, it refreshes and rejuvenates the fabrics, thereby, enhancing the appearance of the fabrics and also improving the sensation of comfort of the wearer in the case of clothes. The method is very efficient (in terms of levels of active used) and easy to implement.

### Emulsion

The emulsion of the invention is an oil-in-water emulsion and comprises a natural-conditioning agent, water, and perfume and other optional ingredients such as surfactants, which act as emulsifiers, organic solvents, preservatives, etc.

Natural-conditioning agent

Preferred conditioning agents suitable for use herein include lipids. Preferred lipids for use as conditioning agents include fats, oils, waxes, monoglycerides, dyglycerides, etc. Conditioning agents of vegetal origin are preferred for use herein and in particular essential oils. Essentials oils not only provide fabric conditioning benefits but they could also impart skin benefits when the fabrics are in proximity to human skin.

Preferably the natural-conditioning agent is of vegetal origin, more preferably an essential oil selected from the group consisting of almond oil, anise oil, apricot kernel oil, avocado oil, aztec marigold oil, balsam of Peru, bay oil, bergamot oil, calendula flower oil, carrot seed oil, castor oil, cedarwood oil, cedar leaf oil, chamomile oil, cinnamon oil, citronella oil, clove oil, coconut oil, corn oil, cypress oil, eucalyptus oil, flax seed oil, geranium oil, grape seed oil, grapefruit oil, hazelnut oil, sunflower oil, jasmine oil, jojoba oil, juniper berry oil, lavender oil, lemongrass oil, lemon oil, lime oil, olive oil, orange oil, palm oil, patchouli oil, peppermint oil, pine oil, rapeseed oil, rose hip seed oil, rose oil, rue, sage oil, sandalwood oil, sesame seed oil, spearmint oil, spruce oil, sweet almond oil, sweet orange oil, tea tree oil, vertivert oil, walnut oil, wheat germ oil, wintergreen oil, ylang ylang oil and mixtures thereof. Specially preferred natural-conditioning agents are almond oil, avocado oil, citronella oil, coconut oil, jasmine oil, jojoba oil and mixtures thereof. Avocado oil is the most preferred conditioning agent.

### Surfactants

Preferably the surfactant, when present, can act as emulsifier to form the oil-in-water (O/W) emulsion. It can also contribute to the softness of the substrate of the natural fabrics treating article. It can be suitably selected from known O/W emulsifiers or combination thereof.

The surfactant can be an anionic surfactant of the sulphate/sulphonate type or preferably a soap derived from a naturally occurring fatty acid such as coconut or palm Such soap can be prepared from the controlled addition of sodium hydroxide solution to natural oils.

The surfactant can be relatively polar and may for instance be selected from surfactants having a HLB value of 10 to 18. Such surfactants are known from the prior art and are, for instance, enumerated in Kirk-Othmer, Enclypedia Of Chemical Technology, third edition, 1979, volume 8, page 913. In the case of ethoxylated products, the HLB value can be calculated according to the formula HLB=(100−L) : 5, where L is the weight proportion of lipophilic groups, e. g. the fatty alkyl of fatty acyl groups.

Preferred non-ionic surfactants can be suitably selected from: ethylenoxide or propylenoxide adducts of fatty alcohols having from 8 to 24 C atoms (in particular 12 to 22 C atoms), (C8-C15 alkyl)-phenol or polyols, containing 2 to 50 mol ethylenoxy and/or 0 to 5 mol propylenoxy units. Alkoxylated fatty alcohol nonionic surfactants have been marketed under the tradenames Neodol and Dobanol by the Shell Chemical Company.

Also preferred for use herein are mono- or di-esters (or mixtures thereof) derived from glycerol, poly-, oligo-or monosaccharides, sugar alcohols or sugar alcohol anhydrides (such as sorbitan), and linear or branched, saturated or unsaturated fatty acids having preferably 6 to 22 carbon atoms. These esters may also be ethoxylated (-EO units), e. g. polysorbate monolaurate +20 EO or polysorbate mono- oleate +20 EO. If the ester is to be liquid, the fatty acid can often be selected from short chain saturated fatty acid, e. g. as in sorbitan monolaurate or from fatty acids having at least one unsaturated fatty acid, as in sobitan sesquioleate.

It is also possible to combine less polar and strongly polar emulsifiers such as the polyol poly (hydroxyesters) (A″) and the alkyl (oligo) glycosides (A′) described below. Expressed in terms of HLB value, a combination of surfactants having HLB values of 2.5 to 5 and 15 to 18 is also useful for the present the invention.

Preferably, a liquid surfactant is used, although the use of minor amounts of solid surfactant is possible depending on the desired viscosity of the resulting emulsion.

An alkyl (oligo) glycoside (A′) which is a nonionic surfactant wherein at least one hydroxy group (typically the C1 hydroxy of the first glycol) of an (oligo) glycoside is linked via at least one ether bond (or ethyleneoxi and/or propyleneoxi units) with an alkyl group-bearing unit (preferably 6 to 28 C atoms in total). The alkyl (oligo) glycoside preferably has the following generic structure (II): R20(CnH2nO) t (glycosyl) x (II) wherein R2 is selected from the group consisting of alkyl, alkylphenyl, hydroxyalkyl, hydroxyalkylphenyl, and mixtures thereof in which the alkyl group contains from 6 to 22 carbon atoms, in particular from 8 to 16 carbon (e. g. 10 to 14 carbon atoms) ; n is 2 or 3, preferably 2,t is from 0 to about 10, preferably 0; x is at least 1, preferably from 1.1 to 5, more preferably 1.1 to 1.6, in particular 1.1 to 1.4, and “glycosyl” is a monosaccharide. The x value is to be understood as the average content of monosaccharide units (oligomerization degree).

The production of alkyl (oligo) glycoside useful in the present invention is known from the prior art and described, for instance in U.S. Pat. No. 4,011,389, U.S. Pat. No. 3,598,865, U.S. Pat. No. 3,721,633, U.S. Pat. No. 3,772,269, U.S. Pat. No. 3,640,998, U.S. Pat. No. 3,839,318, or U.S. Pat. No. 4,223,129.

To prepare these compounds, the alcohol or alkyl- polyethoxy alcohol is typically first formed and then reacted with the (oligo) glycosyl unit to form the (oligo) glycoside (attachment at the 1-position). The glycosyl units can be attached between the C1 position of further glycosyl (s) and the alkyl-group-bearing glycosyl unit's 2-, 3-, 4-and/or 6-position, preferably 6-position.

Preferred starting alcohols R20H are primary linear alcohols or primary alcohols having a 2-methyl branch. Preferred alkyl residues R2 are for instance 1-octyl, 1-decyl, 1-lauryl, 1-myristyl, 1-cetyl, and 1-stearyl, the use of 1-octyl, 1-decyl, 1-lauryl, and 1-myristyl being particularly preferred.

Alkyl (oligo) glycosides useful herein may contain only one specific alkyl residue. Usually, the starting alcohols are produced from natural fats, oils or mineral oils. In this case, the starting alcohols represent mixtures of various alkyl residues.

In preferred embodiments alkyl (oligo)- glycosides are used, wherein R2 consists essentially of C8 and C10 alkyl groups, C12 and C14 alkyl groups, C8 to C16 alkyl groups, or C12 to C16 alkyl groups.

It is possible to use as sugar residue “(glycosyl) x” any mono-or oligosaccharide. Usually, sugars having 5 or 6 carbon atoms as well as the corresponding oligosaccharides are used. Such sugars include, for instance glucose, fructose, galactose, arabinose, ribose, xylose, lyxose, allose, altrose, mannose, gulose, idose, talose and sucrose. It is preferred to use glucose, fructose, galactose, arabinose, sucrose as well as their oligosaccharides, (oligo) glucose being particularly preferred.

In a preferred embodiment “laurylglucoside”, a C12-C16 fatty alcohol-glucoside (x=1.4), which can be obtained from Cognis Deutschland GmbH under the tradename PlantacareO, is used.

Combinations thereof.

It is preferred to use a combination of the emulsifier (N) and (A′) described below, (A″): a liquid polyol polyester wherein a polyol having at least two hydroxy groups is esterified with at least one carboxylic acid having from 6 to 30 carbon atoms (in particular 16 to 22 C atoms) and having at least one hydroxy group or condensation products of this hydroxy fatty acid.

Polyols include monosaccharides, disaccharides, and trisaccharides, sugar alcohols, other sugar derivatives, glycerol, and polyglycerols, e. g. diglycerol, triglycerol, and higher glycerols. Such polyol preferably has from 3 to 12, in particular 3 to 8 hydroxy groups and 2 to 12 carbon atoms (on average, if it is a mixture as in polyglycerols). The polyol preferably is polyglycerol, in particular that having the specific oligomer distribution described in WO 95/34528 (page 5).

The carboxylic acid used in the polyol polyester preferably is a fatty acid having from 6 to 30 carbon atoms (Hereinafter, unless stated otherwise, the term “fatty acid” is not limited to the naturally occurring, even-numbered, saturated or unsaturated long-chain carboxylic acids, but also includes their uneven-numbered homologues or branched derivatives thereof). The fatty acid contains at least one hydroxy group. It can be a mixture of hydroxy fatty acids or a condensation product thereof (poly (hydroxy fatty acids)).

The preferred carbon range for the above mentioned hydroxy fatty acid is from 16 to 22, in particular 16 to 18. A particularly preferred poly (hydroxy fatty acid) is the condensation product of hydroxy stearic acid, in particular 12-hydroxy stearic acid, optionally in admixture with poly (ricinoleic acid), said condensation product having the properties described in WO 95/34528.

Preferred emulsifiers include the polyol poly (hydroxystearates) described in WO 95/34528, in particular polyglycerol poly (hydroxystearates) having the characteristics disclosed in this document, e. g. polyglycerol poly (12-hydroxy stearate), being available from Cognis Deutschland GmbH under the tradename DehymulsX PGPH.

Preferred amounts of (A′) are 1 to 15% by weight, in particular 3 to 8% by weight. Preferred amounts of (A″) are 2 to 15% by weight, in particular 3 to 9% by weight. The weight ratio of A′ to A″ preferably ranges from 0,2 to 2,0, more preferably from 0.5 to 1.5, in particular from 0.8 to 1.2.

Organic solvent

The solvent herein can act as humectant or diluent. Examples of suitable organic solvents suitable herein include: C1-C4 monohydric alcohols and low molecular weight glycols and polyols, including propylene glycol, polyethylene glycol (e.g. of MW 200-600), glycerol, butylene glycol, butane-1, 2, 4-triol, sorbitol esters, hexane- 1, 2, 6 triol, ethanol, iso-propanol, ethoxylated ethers, propoxylated ethers and combinations thereof glycerol, alkylene glyclos, polyalkylene glycols, e. g. polyethylene glycol or polypropylene glycol, for instance polyethylene glycol having a weight average molecular weight of from about 200 to 600; neopentyl alcohols such as pentaerythritol or neopentyl glycol; sugar alcohols such as threitol, erythritol, adonitol (ribitol), arabitol, xylitol, dulcitol, mannitol and sorbitol, carbohydrates such as D (+)-glucose, D (+)-fructose, D (+)-galactose, D (+)-mannose, L-gulose, saccharose, galactose, maltose, polyglycerols, polyoxypropylene adducts of glycerol, methoxypolyethylene glycol, polyethylene glycol ethers of sugar alcohols, such as sorbitol, polyethylene glycol ethers of glycerol, and combinations thereof. Hyaluronic acid may also be used as humectant.

Preferred for use herein are alkylene glycols, in particular propylene glycol

Natural-fabric treating article

Another aspect of the invention is an article for treating natural fabrics, preferably the article is used in a tumble dryer and it is in the form of a sheet. The emulsion of the present invention may be coated or impregnated onto a substrate which carries the emulsion and is capable of releasing it at dryer operating temperatures. The emulsion in turn has a preferred melting (or softening) point from about 25° C. to about 150° C., more preferably from about 30° C. to about 100° C. and especially from about 40° C. to about 80° C.

A highly preferred article comprises the inventive emulsion releasably affixed to a flexible substrate such as a sheet of paper or woven or non-woven cloth substrate. When such an article is placed in an automatic laundry dryer, the heat, moisture, distribution forces and tumbling action of the dryer removes the composition from the substrate and deposits it on the fabrics.

The sheet conformation has several advantages. For example, effective amounts of the emulsion for use in conventional dryers can be easily absorbed onto and into the sheet substrate by a simple dipping or padding process. Thus, the end user need not measure the amount of the emulsion necessary to obtain wool care, refreshing, rejuvenation and other benefits. Additionally, the flat configuration of the sheet provides a large surface area which results in efficient release and distribution of the materials onto fabrics by the tumbling action of the dryer.

The substrates used in the articles can have a dense, or more preferably, open or porous structure. Examples of suitable materials which can be used as substrates herein include paper, woven cloth, and non-woven cloth. The term “cloth” herein means a woven or non-woven substrate for the articles of manufacture, as distinguished from the term “fabric” which encompasses the materials being dried in an automatic dryer.

It is known that most substances are able to absorb a liquid substance to some degree; however, the term “absorbent”, as used herein, is intended to mean a substrate with an absorbent capacity (i.e., a parameter representing a substrates ability to take up and retain a liquid) from 2 to 12, preferably 3 to 7, more preferably 4 to 6 times its weight of water. If the substrate is a foamed plastics material, the absorbent capacity is preferably in the range of 15 to 22, but some special foams can have an absorbent capacity in the range from 3 to 12.

The absorbent capacity of a material can be calculated by weighing (initial weight) a sheet (26 cm×19 cm), completely immersing the sheet in water for 5 seconds. The sheet is then taken out (holding the sheet by a corner) allowing excess water to drain off. The new weight of the sheet is measured (wet weight). The wet weight is divided the initial weight giving the absorbent capacity of the material.

Suitable materials which can be used as a substrate in the invention herein include, among others, sponges, paper, and woven and non-woven cloth, all having the necessary absorbency requirements stated above.

The preferred non-woven cloth substrates can generally be defined as adhesively bonded fibrous or filamentous products having a web or carded fiber structure (where the fiber strength is suitable to allow carding), or comprising fibrous mats in which the fibers or filaments are distributed haphazardly or in random array (i.e. an array of fibers is a carded web wherein partial orientation of the fibers is frequently present, as well as a completely haphazard distributional orientation), or substantially aligned. The fibers or filaments can be natural (e.g. wool, silk, jute, hemp, cotton, linen, sisal, or ramie) or synthetic (e.g. rayon, cellulose ester, polyvinyl derivatives, polyolefins, polyamides, or polyesters).

The preferred absorbent properties are particularly easy to obtain with non-woven cloths and are provided merely by building up the thickness of the cloth, i.e., by superimposing a plurality of carded webs or mats to a thickness adequate to obtain the necessary absorbent properties, or by allowing a sufficient thickness of the fibers to deposit on the screen. Any diameter or denier of the fiber (generally up to about 10 denier-1.11 tex ˜1.11 g/1000 m) can be used, inasmuch as it is the free space between each fiber that makes the thickness of the cloth directly related to the absorbent capacity of the cloth, and which, further, makes the non-woven cloth especially suitable for impregnation with a composition by means of intersectional or capillary action. Thus, any thickness necessary to obtain the required absorbent capacity can be used.

When the substrate for the composition is a non-woven cloth made from fibers deposited haphazardly or in random array on the screen, the articles exhibit excellent strength in all directions and are not prone to tear or separate when used in the automatic clothes dryer. Preferably, the non-woven cloth is water-laid or air-laid and is made from cellulosic fibers, particularly from regenerated cellulose or rayon. Such non-woven cloth can be loaded with the emulsion of the invention.

Preferably, the fibers are from 5 mm to 50 mm in length and are from 1.5 to 5 denier (from 0.167 to 0.556 tex). Preferably, the fibers are at least partially orientated haphazardly, and are adhesively bonded together with a hydrophobic or substantially hydrophobic binder-resin.

Preferably, the cloth comprises about 70% fiber and 30% binder resin polymer by weight and has a basis weight of from about 18 to 45 g per square meter.

In applying the emulsion of the invention to the absorbent substrate, the amount impregnated into and/or coated onto the absorbent substrate is conveniently in the weight ratio range of from about 10:1 to 0.5:1 based on the ratio of total conditioning composition to dry, untreated substrate (fiber plus binder). Preferably, the amount of the conditioning composition ranges from about 5:1 to about 1:1, most preferably from about 4:1 to 1:1, by weight of the dry untreated substrate.

Incorporation and/or impregnation of the emulsion into the substrate is well known in the art. It can be effected, for example, by immersion, spraying, or any other coating technique known in the art. A description can be found, for example, in U.S. Pat. No. 3,442, 692, the content of which is incorporated by reference herein in its entirety. The substrate may then be wrung or pressed to remove excess fluid, and then dried leaving it substantially uniformly treated with the emulsion.

Examples of suitable textile fibre materials which can be treated with the emulsion of the invention are materials made of silk, wool, polyamide, acrylics or polyurethanes, and, in particular, cellulosic fibre materials of all types. Such fibre materials are, for example, natural cellulose fibres, such as cotton, linen, jute and hemp, and regenerated cellulose. Preference is given to textile fibre materials made of cotton. The fabric softener compositions are also suitable for hydroxyl-containing fibres which are present in mixed fabrics, for example mixtures of cotton with polyester fibres or polyamide fibres.

The substrates should be designed to be safe and effective under the intended operating conditions of the method of the invention. The substrates must not be flammable during the process, nor should they deleteriously interact with the emulsion or with the natural fabrics being treated. In general, non-woven polyester-based pads or sheets are quite suitable for use as the substrate herein.

For purposes of illustration, typical single-use polyester sheets suitable for use herein will have a thickness in the range from about 0.1 mm to about 0.7 mm and a basis weight in the range from about 30 g/m.sup.2 to about 100 g/m.sup. 2. Of course, the foregoing dimensions may vary, as long as the desired quantity of the emulsion is effectively provided by means of the carrier.

The substrate used herein is most preferably lint-resistant. By “lint-resistant” herein is meant a substrate which resists the shedding of visible fibers or microfibers onto the fabrics being cleaned, i.e., the deposition of what is known in common parlance as “lint”. A substrate can easily and adequately be judged for its acceptability with respect to lint-resistance by rubbing it on a piece of dark blue woolen cloth and visually inspecting the cloth for lint residues. The lint-resistance of sheet or pad substrates suitable for use herein can be achieved by several means, including but not limited to: preparing the substrate from a single strand of fiber; employing known bonding techniques commonly used with nonwoven materials, e.g., point bonding, print bonding, adhesive/resin saturation bonding, adhesive/resin spray bonding, stitch bonding and bonding with binder fibers. In an alternate mode, a substrate can be prepared using an absorbent core, said core being made from a material which, itself, is not lint-resistant. The core is then enveloped within a sheet of porous, lint-resistant material having a pore size which allows passage of the cleaning compositions, but through which lint from the core cannot pass. An example of such a carrier comprises a cellulose or polyester fiber core enveloped in a non-woven polyester scrim.

### Non-collapsible bag

Problems with the use of an impregnated substrate can arise if the amount of emulsion deposited on it is too high. For example, when the substrate come into contact with a fabric in the tumble-dryer, emulsion can be deposited locally, on the area of actual contact only. The deposition of the emulsion may thus be non-uniform and can produce staining of the fabric. This problem is ameliorated by introducing the fabric and substrate in a non-collapsible bag, thereby minimizing the contact of the substrate and the fabrics. This problem is further compounded because the substrate can become easily rolled, tangled and lodged in the fabric being treated resulting in excessive dispensing of emulsion in one location, with a relatively small distribution of emulsion to the rest of the dryer load. The areas in contact with the fabric may thus become overloaded with emulsion while other areas of the load will not be conditioned at all. Overloading of emulsion in particular areas of fabric may lead to spotting and staining. This, again, is ameliorated by the use of a non-collapsible bag. The level of emulsion on the substrate is another factor that contributes to uniform deposition and avoidance of stains.

The method of the invention is conducted using a flexible non-collapsible bag. The natural fabrics to be treated are placed within the bag, preferably the fabrics are dry, with the substrate containing the emulsion, and the bag is tumbled, thereby delivering the emulsion onto the fabrics.

The bag has sufficient volume for the fabrics to be treated to freely float inside it, preferably the bag is in the form a tetrahedron. Suitable bags can be manufactured from any economical material, such as polyester, polypropylene, and the like, with the proviso that it must not melt if used in contact with hot dryer air. It is preferred that the walls of the container be substantially impermeable to water vapour and/or air under the intended usage conditions. It is also preferred that such bags be provided with a sealing means which is sufficiently stable to remain closed during the treating process. Simple tie strings or wires, various snap closures such as ZIP LOK® closures, and VELCRO®-type closures, contact adhesives, adhesive tape, zipper-type closures, and the like, suffice.

The bag can be of any convenient size, and should be sufficiently large to allow tumbling of the bag and fabrics therein, but should not be so large as to interfere with the operation of the tumbling apparatus. With special regard to containers intended for use in hot air clothes dryers, the container must not be so large as to block the air vents. If desired, the container may be small enough to handle only a single garment.

### EXAMPLE

90 g of avocado oil at 50° C. is mixed with 30 g of Neodol 45-E7 (ex-Shell) and shaken by hand for 10 seconds Immediately following this, 350 g of distilled water at 60° C. is added to the avocado and non-ionic surfactant and the mix is shaken vigorously by hand for one minute to form an emulsion. 30 g of dipropylene glycol is then added and the mix shaken by hand for 10 seconds. Finally 7 g of perfume is added to the hot emulsion and the mix shaken for a further 10 seconds. This emulsion is then poured into a container.

A 26 cm×19 cm sheet of a non-woven material is immersed in the emulsion. The weight of the sheet is 4.3 g and it has an absorbent capacity of 5.6. It is made of a 5 ply construction, with HEC (high elongated carded) polypropylene outer layers and a 3-ply Cellutissue core with a target % open area of 8-12%. The sheet is taken out of the emulsion and squeezed by hand until 14.3 g of the emulsion remains on the sheet.

The emulsion loaded sheet is then placed into an air-impermeable bag of dimensions 45 cm by 55 cm along with a woolen jumper. The bag design is such that it forms a tetrahedron when sealed and inflated. The bag is sealed by means of an airtight zip making sure that some air remains trapped inside the bag. The bag, garment and treatment sheet are then placed in a domestic tumble dryer (Indesit ID60V) and tumbled at 50° C. for 20 minutes. Following this the garment was de-wrinkled, had recovered its natural form and had a pleasing odour and touch.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

What is claimed is:

1. An emulsion for treating natural fabrics, the emulsion comprising by weight of the emulsion:
a) from about 5% to about 40% of a natural-conditioning agent;
b) from about 30% to about 94% of water;
c) from about 0.1% to about 5% of perfume; and
d) less than 5% of cationic surfactant.

2. An emulsion according to claim 1 wherein the natural-conditioning agent is of vegetal origin.

3. An emulsion according to claim 1 wherein the natural-conditioning agent is an essential oil selected from the group consisting of almond oil, anise oil, apricot kernel oil, avocado oil, Aztec marigold oil, balsam of Peru, bay oil, bergamot oil, calendula flower oil, carrot seed oil, castor oil, cedar wood oil, cedar leaf oil, chamomile oil, cinnamon oil, citronella oil, clove oil, coconut oil, corn oil, cypress oil, eucalyptus oil, flax seed oil, geranium oil, grape seed oil, grapefruit oil, hazelnut oil, sunflower oil, jasmine oil, jojoba oil, juniper berry oil, lavender oil, lemongrass oil, lemon oil, lime oil, olive oil, orange oil, palm oil, patchouli oil, peppermint oil, pine oil, rapeseed oil, rose hip seed oil, rose oil, rue, sage oil, sandalwood oil, sesame seed oil, spearmint oil, spruce oil, sweet almond oil, sweet orange oil, tea tree oil, vertivert oil, walnut oil, wheat germ oil, wintergreen oil, ylang ylang oil and mixtures thereof.

4. An emulsion according to claim 1 further comprising a non-ionic and/or an anionic surfactant.

5. An emulsion according to claim 1 further comprising a non-ionic and/or an anionic surfactant at a level of from about 2% to about 20% by weight of the emulsion.

6. An emulsion according to claim 1 wherein the emulsion further comprises an organic solvent.

7. An emulsion according to claim 1 wherein the emulsion further comprises an organic solvent at a level of from about 2% to about 20% by weight of the emulsion.

8. An emulsion according to claim 1 wherein the emulsion is free of cationic surfactant.

9. A natural-fabric treating article for treating natural fabrics, the natural-fabric treating article comprising: a substrate and an emulsion wherein the emulsion comprises by weight of the emulsion:
a) from about 5% to about 40% of a natural-conditioning agent;
b) from about 30% to about 94% of water;
c) from about 0.1% to about 5% of perfume; and
d) less than 5% of cationic surfactant.

10. A natural-fabric treating article according to claim 9 wherein the substrate is a non-woven cloth.

11. A natural-fabric treating article according to claim 9 wherein the substrate is a non-woven cloth having an absorbent capacity in the range of from 3 to 12 times its weight of water.
